(19) United States
(12) Patent Application Publication
(10) Pub. No.: US 2012/0095800 A1
(43) Pub. Date: Apr. 19, 2012

(54) PREDICTING FINANCIAL STATUS OF A PROJECT

(75) Inventors: SAEED BAGHERI, CROTON ON HUDSON, NY (US); DOUGLAS C. BUNCH, RICHARDSON, TX (US); THERESA E. ELL, BRONXVILLE, NY (US); KRISHNA C. RATAKONDA, YORKTOWN HEIGHTS, NY (US); KATRINA M. REFFETT, GREENUP, KY (US); ROSE M. WILLIAMS, WAPPINGER FALLS, NY (US)

(73) Assignee: INTERNATIONAL BUSINESS MACHINES CORPORATION, ARMONK, NY (US)

(21) Appl. No.: 12/905,469

(22) Filed: Oct. 15, 2010

(51) Int. Cl. G06Q 10/00

(52) U.S. Cl. 705/7.23

(57) ABSTRACT

A computer implemented method, system, and/or computer program product predicts the profitability of a current project. Historical data from the current project represents profit data points at predetermined intervals of time during the current project. If a linear regression model of the historical data does not adequately describe the historical data, then a polynomial regression model to describe the historical data is generated. If the polynomial model does not adequately describe the historical data, then another project that is similar to the current project is located. This other project has its own set of historical data. If the historical data from the other project fits the polynomial regression model created from the historical data of the current project, then the polynomial regression model is trusted to accurately predict the profitability of the current project, even though the current project's historical data did not adequately fit the polynomial regression model.

### BACKGROUND

The present disclosure relates to the field of computers, and specifically to the use of computers in project risk management. Still more particularly, the present disclosure relates to the use of computers in predicting a financial status of a project.

### BRIEF SUMMARY

A computer implemented method, system, and/or computer program product predicts the profitability of a current project. Historical data from the current project represents profit data points at predetermined intervals of time during the current project. If a linear regression model of the historical data does not adequately describe the historical data, then a polynomial regression model to describe the historical data is generated. If the polynomial model does not adequately describe the historical data, then another project that is similar to the current project is located. This other project has its own set of historical data. If the historical data from the other project fits the polynomial regression model created from the historical data of the current project, then the polynomial regression model is trusted to accurately predict the profitability of the current project, even though the current project's historical data did not adequately fit the polynomial regression model.

### BRIEF DESCRIPTION OF THE SEVERAL VIEWS OF THE DRAWINGS

FIG. 1 depicts an exemplary computer in which the present disclosure may be implemented;

FIG. 2 is a high level flow chart of one or more exemplary steps taken by a processor to predict a financial status of a project;

FIG. 3 is a graph of historical data points that are inadequately described by a linear regression model line;

FIG. 4 is the graph of historical data points shown in FIG. 3 described by a poorly fitting polynomial regression model line; and

FIG. 5 is a graph from another project whose historical data points adequately fit the polynomial regression model line from the current project.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

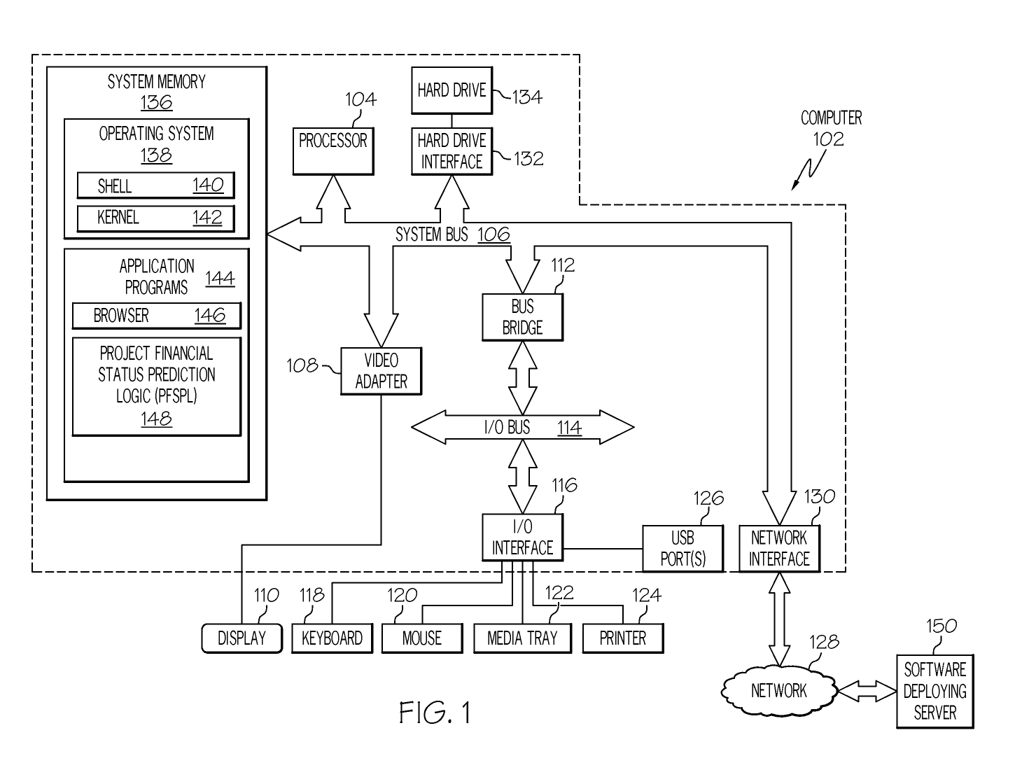

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150.

Computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

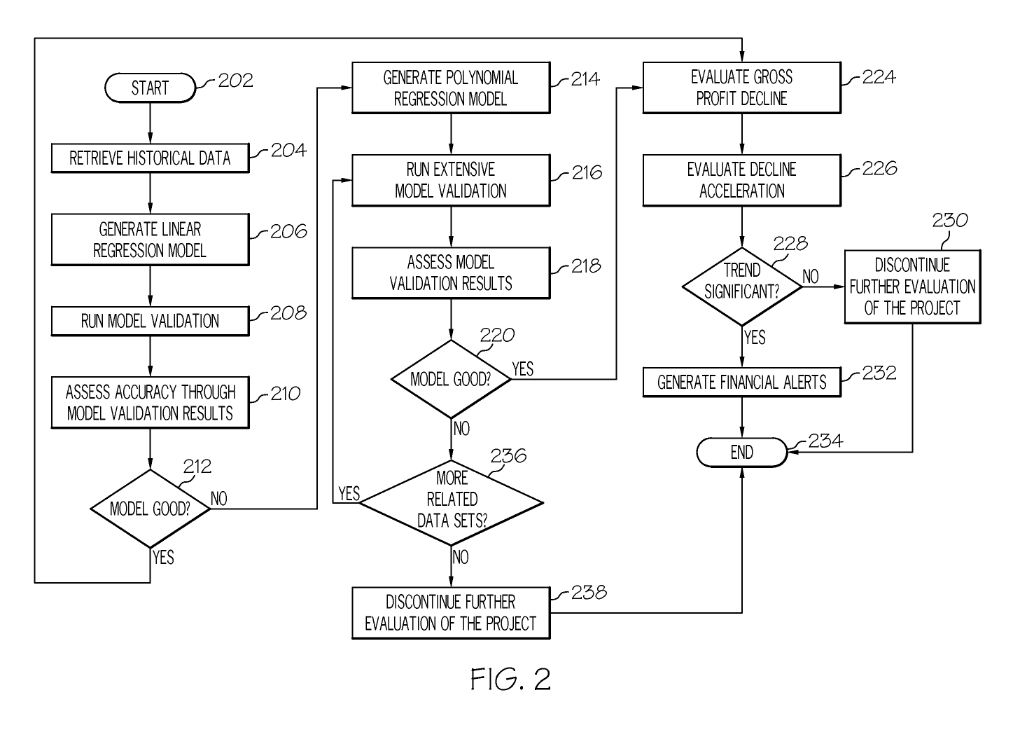

Application programs 144 in computer 102's system memory (as well as software deploying server 150's system memory) also include a project financial status prediction logic (PFSPL) 148. PFSPL 148 includes code for implementing the processes described below, including those described in FIGS. 2-5. In one embodiment, computer 102 is able to download PFSPL 148 from software deploying server 150, including in an on-demand basis, wherein the code in PFSPL 148 is not downloaded until needed for execution to define and/or implement the improved enterprise architecture described herein. Note further that, in one embodiment of the present invention, software deploying server 150 performs all of the functions associated with the present invention (including execution of PFSPL 148), thus freeing computer 102 from having to use its own internal computing resources to execute PFSPL 148.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

Referring now to FIG. 2, a high-level flow chart of one or more exemplary steps performed by a processor to predict a financial status of a current project based on historical data is presented. After initiator block 202, historical data (e.g., monthly gross profit data points) for a current project of a particular category is retrieved from a predetermined period of historical time (e.g., from the last six months of the current project), as described in block 204. Note that, in one embodiment, the current project has already commenced execution. In one embodiment, the particular category of the current project is based on (defined by) the vendor and/or the customer of a project. For example, the particular category may be software projects that have been delivered by a particular vendor; vendor-supplied software projects that are related to a particular field (such as health care); construction projects from a particular contractor and/or for a particular client; etc. In one embodiment, the particular category is based on the type of project being delivered. For example, this particular category may be for projects that deliver specific types of hardware; projects that deliver specific types of software; projects that deliver materials to a particular customer and/or to a customer from a particular field; etc. In one embodiment, the particular category is based on geographic or demographic regions. For example, this particular category may be for projects that deliver products/services/etc. to a specific country; projects that are performed within a specific state; projects that deliver goods to a predetermined population segment; etc.

Regardless of the category that applies to the current project, the data points from the current project are historical data points, such as profit data points, that occur after the current project has commenced. For example, the data points may be monthly gross profit data points (known as MTD) for the first four months of the current project. In another example, the data points are four months of inception to date (ITD) gross profit data points for the current project.

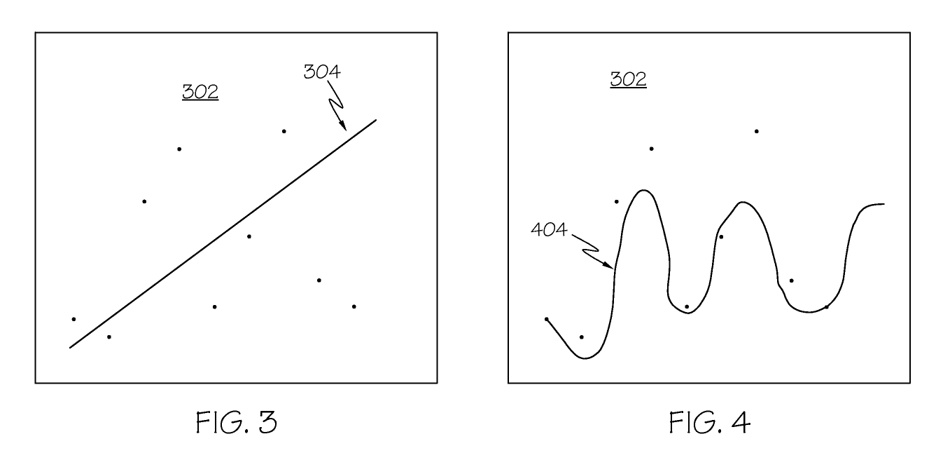

As depicted in block 206, a simple linear regression algorithm is executed to generate a linear regression model for one or both of the vectors (MTD and ITD). For example, the graph 302 shown in FIG. 3 includes MTD and/or ITD profit vectors (sets of data points). The linear regression model for these vectors is represented by line 304. As described in block 208, a simple visual observation (model validation) of line 304 is performed to determine if line 304 adequately describes the data points in the graph 302. As described in block 210, the results of the visual model validation are assessed for accuracy using coefficients from the data points with a student's t-statistical evaluation, an F-distribution test, or other statistical analysis in order to determine “how far away” the data points are from the line 304. If line 304 is deemed (query block 212) to be a good statistical fit based on the model validation and statistical analysis, then an alert (e.g., a financial alert) is generated to describe a predicted profitability of the current project during future predetermined discrete time periods (e.g., the MTD and/or ITD profit for each of the next six months of the project), by executing the process described below in blocks 224, 226, 228, and 232.

However, if the linear regression model inadequately describes the historical data (e.g., the MTD and/or ITD profit vectors shown in graph 302), as determined in query block 212, then a polynomial regression model is generated to describe the historical data from the current project (block 214). This polynomial regression model can be incrementally run using higher orders (e.g., 2^{nd} order, then a 3^{rd} order, then a 4^{th} order, etc. polynomial regression) until a model/line is created that closely describes the MTD and/or ITD profit vectors. However, if the polynomial regression is generated by over feeding data points, such that the resultant descriptive line exactly intersects all data points, then this exceedingly accurate model will not be useful for future predictions, since the endpoint of the line will “point” to a position that is not suggested by the overall trend of the data points.

Consider now FIG. 4, which shows the same graph 302 for the current project's historical data as found in FIG. 3. Now, however, a polynomial regression model of the data points in the graph 302 has been run to generate a curved line 404, which comes closer to mathematically describing the data points in the graph 302 than line 304 shown in FIG. 3.

An extensive model validation (block 216) and an assessment of the model validation results (block 218) is run to the percent of error between the curved line 404 and the data points, as calculated from t statistics, F statistics and other statistical modeling. If the polynomial regression model is a good “fit” (accurate without being over-fed) to the data (query block 220), then the gross profit decline/rise is evaluated visually (block 224) in order to predict future profit/loss of the current project. This prediction is fine tuned by calculating the acceleration of the decline/rise in the profit/loss described in the polynomial regression using second derivative computations of the MTD and/or ITD gross profit data points (block 226). If the decline/rise is deemed significant (query block 228), and more particularly if there is a significant decline in profit based on the polynomial regression model, then a financial alert is generated. This alert describes the predicted profitability (e.g., loss) of the current project during future predetermined discrete time periods. In the case of a decline in profits (including a rise in actual losses), the alert indicates that the project is predicted to continue to decline with the confidence factor of high, medium, or low risk for continued profit decline in the next quarter. These alerts provide an early indication that there is an underlying negative trend occurring before the typical project management metric thresholds are triggered. This enables the management team to examine the project's health status before profit erosion is too significant. Similarly, the alert can be accompanied by, or replaced by, an automatic implementation of a change to the current project based on the information contained in the alert. That is, if the alert indicates that the project will continue to lose money, then the price of the project may be automatically increased if so allowed by terms of the contract and/or service level agreement (SLA) of the current project. However, if the trend is insignificant (query block 228), and there is no intent to re-evaluate the profit points of the project at a later date (during the execution of the project), then no further evaluation of the data points (historical data) are performed (block 230), and the process ends (terminator block 234).

Note that polynomial regressions are discrete (i.e., 2^{nd} order, 3^{rd} order, etc.). As contemplated herein, there may be circumstances in which a 2^{nd} order polynomial regression is too “loose” to accurately describe the data points, while the next (3^{rd} order) polynomial regression may be over-fed. Returning then to query block 220, assume that the polynomial regression model does not accurately describe the historical data, as evidenced by the two lone data points that are far from the curved line 404 shown in FIG. 4. A query is then made to locate data sets (MTD and/or ITD profit vectors) from a similar project (query block 236). Note that the current project and the similar project have at least one common criterion from the particular categories described above. Thus, the current project and the similar project may provide a same product to a same customer in different geographical regions; the similar project and the current project may provide a same product to different customers; the similar project and the current project may provide a different product to a same customer, etc. Furthermore, the current project and the similar project may be executing during a same time period, or the similar project may have concluded execution before the current project began and/or finished.

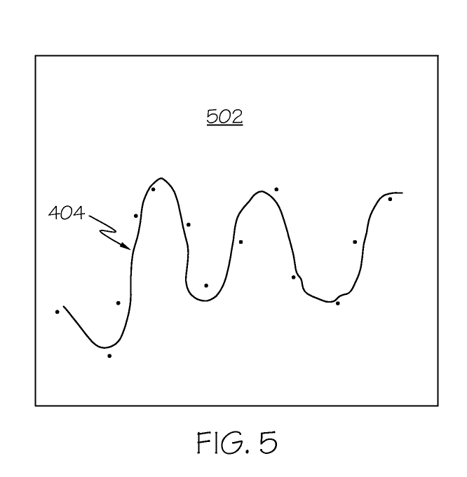

In any embodiment, the data sets for the similar project are other (different) historical data for the similar project, but like the data sets for current project, they represent profit data points at predetermined intervals of time for the similar project after project commencement. An analysis of the data sets from the similar project is made using the process described in blocks 216-220. If the model is still not good (query block 220), then another similar project is located (query block 236) until a project is located that closely matches the polynomial regression model created for the current project, or until no such project can be located (block 238). For example, consider graph 502 shown in FIG. 5. This is a graph of profit data points for a project that is similar to (e.g., same “type” of project) as the current project, but which has different profit data points as the current project. However, the curved line 404 generated in FIG. 4 is a close (without being “too close”) fit to the data points. Thus, since the two projects (the current project and the other similar project) are “similar”, then it can be assumed that the polynomial regression model that generated the curved line 404 is a good predictor for the future profitability of the current project, even though curved line 404 was not a good fit for the actual data points shown in FIG. 4 for the current project.

Note that if the linear regression model of the current project (generated in the process depicted in block 206) adequately describes the other historical data for the similar (other) project, then that linear regression model can be used to predict the profitability of the current project, even if this linear regression model did not accurately describe the profit data points for the current project.

Thus, using the process described herein, if the linear regression model of the current project adequately describes the other historical data for the similar project, then an alert describing the profitability of the current project during future predetermined time periods can be generated. Similarly, if the linear regression model of the current project does not adequately describe the other historical data for the similar project, but the polynomial regression model (or the linear regression model) of the current project does adequately describe the other historical data for the similar project, then an alert describing the predicted profitability of the current project during future predetermined time periods is generated based on the polynomial/linear regression model adequately describing the other historical data for the similar project.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A computer implemented method of predicting future profitability of a current project, the computer implemented method comprising:
a processor receiving historical data from a predetermined past period of time for a current project, wherein the current project has commenced execution, and wherein the historical data represents profit data points at predetermined intervals of time for the current project after commencement;
the processor generating a linear regression model to describe the historical data;
the processor, in response to determining that the linear regression model adequately describes the historical data, generating an alert describing a predicted profitability of the current project during future predetermined discrete time periods;
the processor, in response to determining that the linear regression model inadequately describes the historical data, generating a polynomial regression model to describe the historical data;
the processor, in response to determining that the polynomial regression model adequately describes the historical data, generating the alert describing the predicted profitability of the current project during the future predetermined discrete time periods;
the processor, in response to determining that the polynomial regression model inadequately describes the historical data, locating a similar project that is similar to the current project;
the processor receiving other historical data for the similar project, wherein the other historical data represents profit data points at predetermined intervals of time for the similar project after project commencement;
the processor, in response to determining that the linear regression model of the current project adequately describes the other historical data for the similar project, generating the alert describing the profitability of the current project during future predetermined time periods; and
the processor, in response to determining that the linear regression model of the current project inadequately describes the other historical data for the similar project, and in response to determining that the polynomial regression model of the current project adequately describes the other historical data for the similar project, generating the alert describing the predicted profitability of the current project during future predetermined time periods based on the polynomial regression model adequately describing the other historical data for the similar project.

2. The computer implemented method of claim 1, wherein the predicted profitability of the current project is for a financial gain.

3. The computer implemented method of claim 1, wherein the predicted profitability of the current project is for a financial loss.

4. The computer implemented method of claim 1, wherein the profit data points represent gross profit data points for the current project.

5. The computer implemented method of claim 1, wherein the similar project and the current project provide a same product to a same customer in different geographical regions.

6. The computer implemented method of claim 1, wherein the similar project and the current project provide a same product to different customers.

7. The computer implemented method of claim 1, wherein the similar project and the current project provide a different product to a same customer.

8. The computer implemented method of claim 1, wherein the similar project is currently executing during a same time period as the current project.

9. The computer implemented method of claim 1, wherein the similar project completed execution before the current project commenced.

10. The computer implemented method of claim 1, further comprising:
the processor automatically implementing a change to the current project based on the information contained in the alert.

11. A computer program product for predicting future profitability of a current project, the computer program product comprising:
a computer readable storage media;
first program instructions to receive historical data from a predetermined past period of time for a current project, wherein the current project has commenced execution, and wherein the historical data represents profit data points at predetermined intervals of time for the current project after commencement;
second program instructions to generate a linear regression model to describe the historical data;
third program instructions to, in response to determining that the linear regression model adequately describes the historical data, generate an alert describing a predicted profitability of the current project during future predetermined discrete time periods;
fourth program instructions to, in response to determining that the linear regression model inadequately describes the historical data, generate a polynomial regression model to describe the historical data;
fifth program instructions to, in response to determining that the polynomial regression model adequately describes the historical data, generate the alert describing the predicted profitability of the current project during the future predetermined discrete time periods;
sixth program instructions to, in response to determining that the polynomial regression model inadequately describes the historical data, locate a similar project that is similar to the current project;
seventh program instructions to receive other historical data for the similar project, wherein the other historical data represents profit data points at predetermined intervals of time for the similar project after project commencement;
eighth program instructions to, in response to determining that the linear regression model of the current project adequately describes the other historical data for the similar project, generate the alert describing the profitability of the current project during future predetermined time periods; and
ninth program instructions to, in response to determining that the linear regression model of the current project inadequately describes the other historical data for the similar project, and in response to determining that the polynomial regression model of the current project adequately describes the other historical data for the similar project, generate the alert describing the predicted profitability of the current project during future predetermined time periods based on the polynomial regression model adequately describing the other historical data for the similar project; and wherein
the first, second, third, fourth, fifth, sixth, seventh, eighth, and ninth program instructions are stored on the computer readable storage media.

12. The computer program product of claim 11, wherein the profit data points represent gross profit data points for the current project.

13. The computer program product of claim 11, wherein the similar project and the current project provide a same product to a same customer in different geographical regions.

14. The computer program product of claim 11, wherein the similar project is currently executing during a same time period as the current project.

15. The computer program product of claim 11, further comprising:
tenth program instructions to automatically implement a change to the current project based on the information contained in the alert; and wherein the tenth program instructions are stored on the computer readable storage media.

16. A computer system comprising:
a central processing unit (CPU), a computer readable memory, and a computer readable storage media;
first program instructions to receive historical data from a predetermined past period of time for a current project, wherein the current project has commenced execution, and wherein the historical data represents profit data points at predetermined intervals of time for the current project after commencement;
second program instructions to generate a linear regression model to describe the historical data;
third program instructions to, in response to determining that the linear regression model adequately describes the historical data, generate an alert describing a predicted profitability of the current project during future predetermined discrete time periods;
fourth program instructions to, in response to determining that the linear regression model inadequately describes the historical data, generate a polynomial regression model to describe the historical data;
fifth program instructions to, in response to determining that the polynomial regression model adequately describes the historical data, generate the alert describing the predicted profitability of the current project during the future predetermined discrete time periods;
sixth program instructions to, in response to determining that the polynomial regression model inadequately describes the historical data, locate a similar project that is similar to the current project;
seventh program instructions to receive other historical data for the similar project, wherein the other historical data represents profit data points at predetermined intervals of time for the similar project after project commencement;
eighth program instructions to, in response to determining that the linear regression model of the current project adequately describes the other historical data for the similar project, generate the alert describing the profitability of the current project during future predetermined time periods; and
ninth program instructions to, in response to determining that the linear regression model of the current project inadequately describes the other historical data for the similar project, and in response to determining that the polynomial regression model of the current project adequately describes the other historical data for the similar project, generate the alert describing the predicted profitability of the current project during future predetermined time periods based on the polynomial regression model adequately describing the other historical data for the similar project; and wherein
the first, second, third, fourth, fifth, sixth, seventh, eighth, and ninth program instructions are stored on the computer readable storage media for execution by the CPU via the computer readable memory.

17. The computer system of claim 16, wherein the profit data points represent gross profit data points for the current project.

18. The computer system of claim 16, wherein the similar project and the current project provide a same product to a same customer in different geographical regions.

19. The computer system of claim 16, wherein the similar project is currently executing during a same time period as the current project.

20. The computer system of claim 16, further comprising:
tenth program instructions to automatically implement a change to the current project based on the information contained in the alert; and wherein the tenth program instructions are stored on the computer readable storage media for execution by the CPU via the computer readable memory.
